(19) United States
(12) Patent Application Publication
(10) Pub. No.: US 2026/0152975 A1
(43) Pub. Date: Jun. 4, 2026

(54) OPENING DEVICE FOR A MOTOR VEHICLE DOOR ELEMENT

(71) Applicant: KIEKERT AKTIENGESELLSCHAFT, Heiligenhaus (DE)

(72) Inventors: Thorsten BENDEL, Oberhausen (DE); Uwe REDDMANN, Essen (DE)

(73) Assignee: KIEKERT AKTIENGESELLSCHAFT, Heiligenhaus (DE)

(21) Appl. No.: 18/724,906

(22) PCT Filed: Jan. 2, 2023
(86) PCT No.: PCT/DE2023/100001

§ 371 Date: Jun. 27, 2024

(30) Foreign Application Priority Data
Jan. 11, 2022 (DE) 10 2022 100 510.0

(51) Int. Cl. E05B 81/18; E05B 79/20; E05B 81/06; E05B 81/28; E05B 81/34

(52) U.S. Cl. CPC E05B 81/18; E05B 79/20; E05B 81/06; E05B 81/28; E05B 81/34

(57) ABSTRACT

An opening device for a motor vehicle door element (2) comprising an electrically operable locking system, an electric drive and an actuator, wherein the actuator is adjustable by means of the drive and a gear arranged between the actuator and the electric drive such that it is possible for the door element to move, wherein the actuator is designed as an at least partially flexible actuator.

The invention relates to an opening device for a motor vehicle door element, comprising an electrically operable locking system, an electric drive, and an actuator, wherein the actuator is adjustable by means of the drive and a gear arranged between the actuator and the drive, so that a movement of the door element is made possible.

Today's motor vehicles are increasingly being provided with convenience functions. For example, in order to make it easier to get into a motor vehicle and to be able to influence the aesthetic and aerodynamic shape, motor vehicles are equipped, for example, without an outer door handle. It is also conceivable, however, that an outside door handle be provided, but this only forward a switching signal to the motor vehicle door latch to open it. In order to facilitate and automate getting into vehicles and, for example, to allow for getting into vehicles without handles on the outside of the door, so-called opening devices or door openers, some of which are also referred to as door positioners, are used.

A positioner for motor vehicle doors or flaps, by which a door, flap, or hood can be moved from a closed position into an open position, is known from DE 10 2011 015 669 A1. If the positioning apparatus relates, for example, to a motor vehicle side door, the door can be opened by means of an electrical pulse. For this, the locking mechanism of the door latch must first be unlocked—preferably electrically—so that the door can be opened. If, for example, the door sealing pressure is not sufficient to move the door from the closing position into an open position, the door can be moved into an open position by means of the opening device. An open position is defined here in such a way that the operator of the motor vehicle is able to grasp the door so that he can fully open the door. An electric drive unit is used as the opening device, which acts mechanically on the motor vehicle door in the form of a pivoting movement of the levers via a drive pawl and an inner and outer lever.

DE 10 2016 105 760 A1 discloses an opening device for a motor vehicle door with a base plate, furthermore with a drive element mounted on the base plate, and a drive unit, wherein a first sensor assigned to the drive element is provided which distinguishes at least between an opening process and a manual opening process. The opening device comprises a drive which can be driven via a sensor and a control unit. A flexible connecting means then makes it possible to pivot a transmission lever, which in turn allows an opening movement via a drive lever and a drive slide. In order to allow the door to be moved, the drive slide moves linearly and, for example, out of an opening in a body so that an unlatched and unlocked door can be opened at least in some regions. The end position of the drive slide can be detected by means of a second stationary sensor so that the drive can be switched off again.

From the applicant's patent application, DE 10 2017 124 282 A1, an opening device for a motor vehicle door element has become known, having an electric drive and an actuator, wherein the actuator is adjustable by means of the drive and a gear arranged between the actuator and the drive. The door can be moved by means of the opening device, wherein a sliding element is arranged on the actuator and interacts with a switching means so that the door movement can be detected. The actuator is substantially formed from a driven toothed rack having an integrated sliding element, switching means, and electrical supply line. It is possible to control the movement of the driven toothed rack by means of the switching means between the sliding element and the body.

The generic state of the art is formed by the applicant's unpublished patent application (DE 10 2018 132 665 A1). The document discloses an opening device for a motor vehicle door element having an electric drive and an actuator, wherein the actuator is adjustable by means of the drive and a gear arranged between the actuator and the drive, with the result that a movement of the door element can be made possible, and the opening device also has a sensor for detecting the door movement, wherein the door element can be held by means of the actuator. By use of a latching means, the opening device is able to open the door element and to hold it in the opened position. In addition, there is the possibility of moving the door element into a closed position by means of the opening device.

The opening devices known from the state of the art have basically proven themselves, but reach their limits when there is insufficient space available for the installation of the opening device in, for example, a side door or a B-pillar of a motor vehicle. This is where the invention starts.

The object of the invention is to provide an improved opening device for a motor vehicle door element. In addition, it is an object of the invention to provide an opening device which takes up as little space as possible while providing maximum functionality. The opening device shall have a simple and inexpensive design.

The object is achieved by the features of independent claim 1. Advantageous embodiments of the invention are specified in the dependent claims. It should be noted that the exemplary embodiments described below are not restrictive; rather, any variation of the features described in the description and the dependent claims is possible.

According to claim 1, the object of the invention is achieved in that an opening device for a motor vehicle door element is provided, having an electrically operable locking system, an electric drive, and an actuator, wherein the actuator is adjustable by means of the drive and a gear arranged between the actuator and the drive, such that a movement of the door can be made possible, wherein the actuator is designed as an at least partially flexible actuator. The design according to the invention of the opening device now makes it possible to make the opening device as small as possible. Due to the flexibility of the actuator, the actuator can be deflected at least in the door element area, which makes a space-saving design of the opening device possible. The flexibility of the actuator makes it possible, on the one hand, to use the actuator to open the door element and, on the other, due to the flexibility, to guide it in the door element in such a way that the actuator can also be used when, for example, the installation space in a door is limited by a pane guide. The actuator has a dual function here. On the one hand, the actuator is able to provide an opening force, i.e., an axial force for opening the door element, and on the other, the actuator can, for example, be deflected and stowed in a stowage space. This dual function ensures the full functionality of the opening device while at the same time making possible a space-saving integration into a motor vehicle door element or motor vehicle body.

Even when the opening device in the exemplary embodiment and/or in the description is shown in an installation position in a door of a motor vehicle, this installation position is not restrictive. It is rather the case that the opening device can also be used where, for example, hinged panels, hoods, or covers are arranged in the motor vehicle. The opening device can either be arranged in a component that is movably arranged on the motor vehicle, or it can be integrated into the motor vehicle body. The opening device here makes possible a relative movement between the body and the component movably arranged on the motor vehicle, so that it can be easily grasped by the operator of the motor vehicle.

The opening device works together with an electric lock so that the operator has only to generate a signal in order to move the vehicle door element from a main closed position into an open position or engagement position. An operator of the motor vehicle basically sends a signal to a control unit of the motor vehicle, whereby the electrically operated lock is opened and moved from a main locking position to an unlocked position. By means of the opening device, the motor vehicle door element or the component movably arranged on the motor vehicle can then be moved into a position in which the operator can grasp the door element and open it—for example, in order to get in. The opening device is thus used to move the door element into an engagement position that is convenient for the user. The combination of electric locking system and opening device significantly increases the comfort of the vehicle and makes getting into or operating the vehicle easier.

The opening device comprises an electric drive, which is preferably designed as an electric DC motor. DC motors are advantageous because a supply voltage can be easily provided by the motor vehicle. In addition, electric motors have short control and regulation times, so that electrical opening can be achieved in the shortest possible time. The electric drive interacts with an actuator, preferably by means of a gear. To provide sufficient actuating force to enable the vehicle door element to be opened even in extreme situations, high forces are required. To be able to provide an inexpensive opening device, small electric motors are preferably used, which can then by means of a gear provide sufficient power for opening. An extreme situation can occur, for example, when door sealing is made more difficult by environmental influences, such as cold. By means of the electric drive and the gear, forces of up to 600 N, preferably 800 N and even more preferably 1,000 N, can be provided. The door element can therefore make possible a positioning of the door element even in extreme situations.

The electric drive unit preferably consists of a direct current motor which interacts with an output shaft and, for example, via a worm gear, with the actuator. One-, two- or multi-stage gear mechanisms are conceivable, wherein the selection of the gear mechanism can influence the force available at the actuator. If, for example, the opening device is arranged in the door element in such a way that the opening device interacts, for example, with an A-pillar of the motor vehicle and a front door, higher forces will be required to open the door element than when the opening device is in turn arranged in a front door of a motor vehicle and acts upon a B-pillar in the motor vehicle. In the case of an opening of a door and the opening device being arranged in the region of the motor vehicle lock, lower forces are required, with the result that higher ratios can be used.

The electric drive unit here makes it possible for the actuator to move. By means of the electric motor, it is possible to move the actuator in such a way that the door can be opened by the driven actuator. The actuator moves relative to the body and exerts a compressive force on the vehicle motor vehicle door element so that the unlatched and unlocked door can be moved.

The opening device preferably interacts with a motor vehicle lock which has a rotary latch and at least one pawl, wherein the locking mechanism comprising the rotary latch and at least one pawl can be unlocked electrically. Particularly in the case of electrically unlockable locking systems, the operator of the motor vehicle needs only an electrical pulse to move the locking system into an unlocked, i.e., open, position. The closing system is then open, so that the door or panel can be moved. The electrical opening pulse for the motor vehicle lock can be generated by means of a sensor, a key, or, for example, a sensitive means, such as a touch sensor, or an outside door handle with an integrated sensor.

In a variant embodiment of the invention, the actuator is guided in the door element or the body in a deflectable manner. A deflection makes it possible to place the actuator in the smallest possible installation space. The actuator can also be deflected several times, so that an actuator stowage space is created. In the actuator stowage space, the actuator can then be deflected several times or, for example, can be wound up. In any case, the deflection makes it possible for the actuator to be arranged in a door or a part of the body where the installation space is independent of the actuating distance of the opening device. This means that even large adjustment movements can be performed by means of the opening device without the need to provide the necessary installation space in the door element or the body.

If the actuator takes the form of a push chain, this results in a preferred embodiment of the invention. A push chain offers the advantage that, on the one hand, a movement of the door element can be initiated by means of the actuator and, on the other, the chain links can be deflected in at least one direction. By the arrangement of a push chain, sufficient force can be provided to open the door element and at the same time for it to be possible to deflect the actuator and insert it into an actuator stowage space. The push chain can also be advantageously combined with the electric drive, since the push chain can be driven by means of a gearwheel. In this way, the electric drive in combination with the gear can be used advantageously and with the smallest possible number of components to drive the push chain. Particularly advantageous here is that pulling and pushing movements can be realized using a push chain. The push chain consists of individual chain links which can be transferred into a stable position by a linear arrangement one behind the other as seen in the axial direction. Only when it is deflected, and in particular when it is deflected via a gearwheel, does the push chain lose its stability and become able to be introduced into an actuator stowage space.

In a further advantageous design variant of the invention, an advantage arises when the actuator comprises a Bowden cable. A Bowden cable, consisting of a Bowden cable core and a Bowden cable sheath, can be deflected, and thus integrated into a door or body of the vehicle in a space-saving manner. Advantageously, the Bowden cable can be provided with an electric drive which can be arranged at a distance from the actuator. This increases the degree of flexibility during installation of the opening device. Preferably, twisted Bowden cable cores are used so that compressive forces can be transmitted by means of the Bowden cable or the Bowden cable core. The Bowden cable then interacts with the actuator in such a way that the actuator can be moved by means of the Bowden cable. The Bowden cable core is brought into engagement with the actuator and can be operated by means of the electric drive.

In a further embodiment of the invention, the Bowden cable interacts with a telescopic extension. The Bowden cable or the Bowden cable core can be routed within the telescopic extension or only operate the telescopic extension. The actuator as a combination of a telescopic extension and a Bowden cable then acts upon the door element and thus makes possible an adjustment movement of the door element. The Bowden cable sheath can, for example, be fixedly integrated into the door element and the telescopic guidance and/or extension means be moved out of the door element by means of the Bowden cable core, wherein the extension can be brought into engagement with the body so that a movement of the door element is made possible. The telescopic extension thus serves as an actuator and can at the same time be used to stabilize the driving Bowden cable core. The design of the actuator as a telescopic rod on one hand makes it possible for the Bowden cable or the Bowden cable core to be stabilized, and at the same time the actuator can be pushed together, whereby only a little space is required for the actuator and thus for the opening device. The extension can consist of two, three, or more individual parts that can be telescopically pushed into one another in the manner of an extendable antenna. This means that only a low height or short axial length of the extension is required as installation space in order to accommodate the extension in the door element, for example. The extension is preferably made of steel and/or a high-strength plastic.

Advantageously, a guide for the actuator can be provided, which results in a further design variant of the invention. Depending upon the installation position of the opening device in the body or the door element, an exit opening is provided in the body or the door element. Advantageously, the opening is provided with a guidance means, wherein the guidance means on the one hand acts as a sliding partner for the actuator, and at the same time makes a guide for the actuator possible. Advantageously, the guidance means can consist of a plastic. Plastics and in particular plastics with good sliding properties are preferred here, so that, in addition to the guidance, favorable friction properties can be provided for the movement of the actuator. Plastics with good sliding properties and/or integrated lubricating and/or sliding substances are particularly suitable. An example of a plastic with good sliding properties and high strength is Teflon. Teflon-coated guide elements made of a metallic material, for example, can also be used. Advantageously, the guidance means encloses the actuator at least in part, but preferably completely. The guidance means can extend axially along a central axis of the actuator in the opening device. The guidance means thus serves to secure the position and can ensure safe opening, holding, and positioning of the actuator during movement of the actuator. If a push chain is used, the guidance means can also be used to align the push chain in a stable position. Here, the guidance means can comprise an insertion aid and/or a positioning aid—for example, as a lead-in chamfer. The insertion or positioning aid can enclose the actuator in certain regions, but preferably completely, so that the actuator can be guided reliably and, in particular, the actuator can be aligned reliably for moving the door element.

In a further embodiment variant of the invention, the actuator has a buffer and/or holding means at one axial end. The actuator is led out of an opening, e.g., in the door element, and brought into contact with, for example, the body of the motor vehicle. In order to increase the comfort level, a buffer element can be arranged on the actuator, viz., at an axial end which comes into engagement with the body. The buffer element reduces noise during opening, thus increasing the comfort level. At the same time, it is possible to form the buffer element or a separate holding element on the actuator, so that reliable opening is possible. As a buffer element, an elastomeric material can preferably be used, which can be connected to the actuator as a separate component or is injection-molded onto the actuator—for example, using a plastic injection-molding process.

A further advantage emerges if the actuator can be brought into positive-locking connection with a body of the motor vehicle or with the door element. In order to create a positive-locking connection between the actuator and the body or a door element, the buffer and/or holding means can, for example, be brought into positive-locking connection with a receptacle on the motor vehicle. For example, the buffer element can engage positively in the receptacle, so that the door element can be moved safely. The positive-locking connection between the buffer and/or holding means and the receptacle can be dimensioned in such a way that, on the one hand, the moving door element can be held, but, in the event of a manual movement of the door element, the positive-locking connection can be easily released. This means that the door element can be secured against unintentional opening, and at the same time it is possible to transmit thrust and compressive forces by means of the opening device. It is also conceivable that a separate holding means engage in a positive-locking manner in the body or the motor vehicle, whereby the buffer and/or holding means engages behind the receptacle at least in some areas. The holding means can, for example, interact with a spring means, wherein the spring force is dimensioned such that the door element can be held and positioned, but the operator is always able to release the door element from engagement with the actuating element. The positive-locking connection with the body or the door element can be one-sided, two-sided, or all-round, or result from an interaction between the actuator and the receptacle. It is also possible for the receptacle itself to be constructed in such a way that holding the door element is made possible, wherein the receptacle can, for example, have an undercut. It is of course also conceivable that the actuator have an undercut, which then engages positively into the body or the door element so that a secure opening of the door element can always be guaranteed. With an opening device designed according to the invention, a compact, extremely small opening device can be provided which takes up as little space as possible in the motor vehicle and at the same time can make possible a secure positioning as well as a closing of the door element.

In the following, the invention is explained in more detail with reference to the appended drawings using an embodiment. However, the principle applies that the exemplary embodiment does not limit the invention, but merely represents one embodiment. The features depicted can be implemented individually or in combination with further features of the description as well as what is claimed-individually or in combination.

### IN THE FIGURES

FIG. 1 is a schematic representation of a view of an opening device designed according to the invention in a section and in a side view of the opening device, arranged in a door element, in engagement with the body, wherein the actuator is shown partially extended from the door element, and

FIG. 2 is an alternative embodiment of an opening device with an actuator of telescopic design, wherein the actuator is again shown in an extended position and in engagement with a body of the motor vehicle.

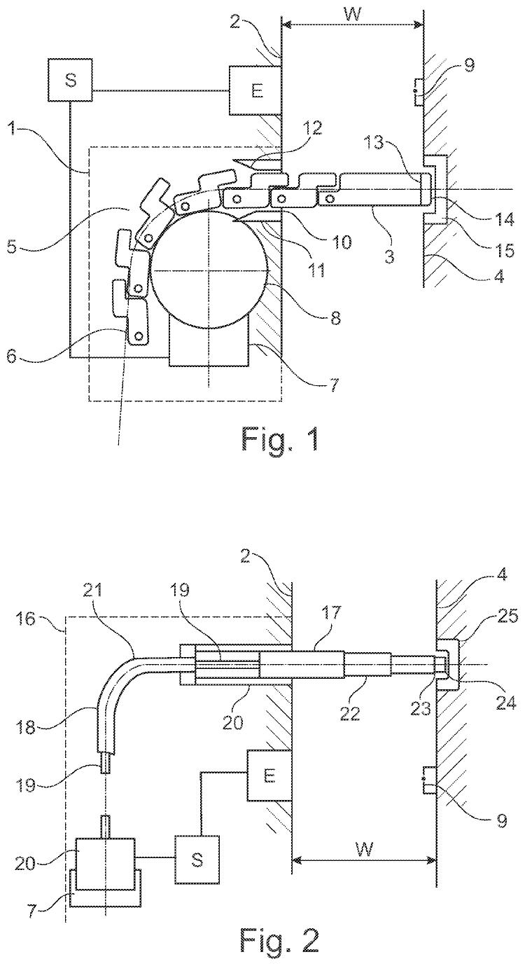

FIG. 1 shows an opening device 1 in a basic representation and in a side view of the opening device, wherein the opening device 1 is integrated into a door element 2 and wherein an actuator 3 abuts a body 4 of a motor vehicle. In this exemplary embodiment, the actuator 3 is designed as a drag chain 5, wherein the drag chain 5 can be deflected along a center line 6 in the opening device 1. The drag chain 5 is driven by means of an electric drive 7, wherein the electric drive interacts at least indirectly with a gearwheel 8, wherein the drag chain 5 can be driven and moved by means of the gearwheel 8. In this exemplary embodiment, the opening device 1 is integrated into a door element 2 that is movably mounted on the motor vehicle 4. In addition, an electric lock E is installed in the door element 2, wherein the electric lock E can be brought into engagement with a lock holder 9 indicated by a dash-dot line. The electric drive 7 and the electric lock E are both electrically connected to a control unit S, so that an interaction between the electric lock E and the electric drive 7 is made possible.

The actuator 5 is shown in a position in which it is at least partially extended out of an opening 10 of the door element 2. Here, the door element 2 has been opened over a distance W by means of the actuator 3. The actuator is positioned and guided by means of a guidance means 11, wherein the guidance means 11 has an insertion aid 12 so that a secure positioning of the drag chain 5 and an alignment of the drag chain 5 in a linear alignment is made possible. The actuator thus has a linearly aligned region which extends along the distance W outside the opening 10 and a deflected region which reaches around the gearwheel 8. A deflection around the gearwheel 8 is shown, whereby a further deflection and a receptacle for the actuator in an actuator stowage space can also be possible.

The actuator 3 has a buffer and/or holding means 14 at an axial end 13, wherein the buffer and/or holding means 14 interacts with a receptacle 15. Of course, it is also possible for the buffer and/or holding means 14 to be able to be brought to engage directly with the body 4. In this exemplary embodiment, the buffer and/or holding means 14 interacts with a separately formed receptacle 15 in the body 4, so that, for example, a positive-locking connection can be established between the buffer and/or holding element 14 and the receptacle 15. It is also conceivable for the receptacle 15 itself to be designed as a component made of plastic and thus as a buffer element, whereby it can be possible for the door element 2 to be opened with little noise.

In a closed position of the door element 2, the lock E engages with the lock holder 9 and secures the door element 2 while the motor vehicle is traveling. If, for example, an electrical signal is transmitted to the control unit S in a parking position of the motor vehicle, e.g., via a radio remote control unit, the electric lock E will receive a control command and unlock the electric lock. Unlocking here means that the lock holder 9 is released by a locking mechanism arranged in the lock E and consisting of a rotary latch and at least one pawl. The now released door 2 can now also be operated by means of a control signal from the control unit S and a control signal at the electric drive 7 of the opening device 1. For this purpose, the actuator 3 is moved out of the opening 10 so that the actuator 3 comes into engagement with the body 4 and opens or moves the door element 2. By designing the actuator 3 as a flexible actuator, the opening device 2 can be integrated into the door element 2, viz., with the smallest possible space requirement, wherein the space requirement is in particular not tied to the actuating distance W and thus to a length of the actuator 3.

In FIG. 2, an alternative embodiment of an opening device 16 is also shown in section through the opening device and in a basic representation. Identical components are provided with the same reference signs. In this design variant, the opening device 16 has an actuator 17 which can be described as being extendable in a telescopic manner. The actuator 17 is actuated by means of a Bowden cable 18, wherein a Bowden cable core 19 is guided into the actuator 17 and moves the actuator 17. For this purpose, the Bowden cable core can be designed as a twisted Bowden cable core, so that a pulling and pushing movement can be performed by means of the Bowden cable 18. In addition, the Bowden cable core 19 can be guided within the actuator 17. A guidance means 20 is once again formed on the door element 2, wherein the guidance means 20 in this embodiment serves for linear guidance of the actuator 17. The Bowden cable 18 is operated by means of an electric drive 7 and via, for example, a spindle drive 20. The Bowden cable 20 is deflected within the opening device 16, so that the installation depth of the opening device 16 is independent of the actuating distance W of the opening device 16. The Bowden cable sheath 21 can, for example, be fixedly held by the guidance means 20, so that a secure guidance and application of a tensile force in the actuator 17 can be ensured.

The actuator 17 can be extended telescopically, whereby the elements 22 of the actuator can be pushed into one another and guided against one another. At an axial end 23 of the actuator 17, a buffer and/or holding element 24 is arranged, wherein the buffer and/or holding element 24 interacts with a receptacle 25 in the body 4. By means of the opening device 16, it is thus possible to open the door element 2 in relation to the body 4 and thus to enable the door element 2 to be opened in order to increase the comfort level of the motor vehicle.

List of reference signs

| | |
|---|---|
| 1, 16 | Opening device |
| 2 | Door element |
| 3, 17 | Actuator |
| 4 | Vehicle body |
| 5 | Drag chain |
| 6 | Center line |
| 7 | Electric drive |
| 8 | Gearwheel |
| 9 | Lock holder |
| 10 | Opening |
| 11, 20 | Guidance means |
| 20 | Insertion aid |
| 13, 23 | Axial end |
| 14, 24 | Buffer and/or holding means |
| 15, 25 | Receptacle |
| 18 | Bowden cable |
| 19 | Bowden cable core |
| 20 | Spindle drive |
| 21 | Bowden cable sheath |
| 22 | Elements |
| E | Electric lock |
| S | Control unit |
| W | Distance |

1. An opening device for a motor vehicle door element, comprising:
an electrically operable locking system, an electric drive, and an actuator, and
a gear arranged between the actuator and the electric drive,
wherein the actuator is adjustable by operation of the drive and the gear to move the door element, and wherein the actuator is at least partially flexible.

2. The opening device according to claim 1, wherein the actuator is guided in a deflectable manner in the door element.

3. The opening device according to claim 1, wherein the actuator is designed as a drag chain including a plurality of chain links.

4. The opening device according to claim 1, wherein the actuator comprises a Bowden cable.

5. The opening device according to claim 4, further comprising a telescopic extension in which a core of the Bowden is routed, wherein the Bowden cable interacts with the telescopic extension to move the door element.

6. The opening device according to claim 1, further comprising a guide arrange along a central axis of the actuator in which the actuator slides.

7. The opening device according to claim 6, wherein the guide has an insertion aid comprising a lead-in chamfer.

8. The opening device according to claim 1, wherein the actuator has a buffer and/or a holder at one axial end.

9. The opening device according to claim 8, wherein the actuator is brought into positive-locking engagement with a body of the motor vehicle or with the door element via engagement with the buffer.

10. The opening device according to claim 1, wherein a thrust and compressive force is transmitted by the actuator.

11. The opening device according to claim 1, further comprising an actuator storage space in which the actuator is deflected for storage of the actuator.

12. The opening device according to claim 1, further comprising a gearwheel, and deflection of the actuator is performed by winding the chain links around the gearwheel.

13. The opening device according to claim 6, wherein the guide is made of plastic.

14. The opening device according to claim 8, wherein the buffer is made of an elastomeric material.

15. The opening device according to claim 8, wherein the holder includes a spring.
